(19) United States
(12) Patent Application Publication
(10) Pub. No.: US 2021/0148676 A1
(43) Pub. Date: May 20, 2021

(54) METHOD AND FILM FOR GENERATING THERMAL AND VISUAL DECEPTION USING METAL IMAGE LITHOPHANE PRINTING AND AN ALPHA COMPOSITING METHOD FOR CAMOUFLAGE, SHADOW ELIMINATION, AND BACKGROUND BLENDING

(71) Applicant: NOKOMIS, INC., CHARLEROI, PA (US)

(72) Inventor: JOEL B. ROVNER, WEST NEWTON, PA (US)

(73) Assignee: NOKOMIS, INC., CHARLEROI, PA (US)

(21) Appl. No.: 16/671,301

(22) Filed: Nov. 1, 2019

(51) Int. Cl. F41H 3/02; B32B 15/08

(52) U.S. Cl. CPC F41H 3/02; B32B 2307/404; B32B 2307/416; B32B 15/08

(57) ABSTRACT

A flexible multi-layered film with a printed deceptive image that mimics in the visual and infrared spectrum a landscape and/or an object. The image layer has an edge portion that has an irregularly cut pattern, that is lightened, and made transparent to blend into the surrounding environment and eliminate shadows. The image layer also has a variable concentration of a metal or high emissivity ink image and a color ink image. The film base layer is a thermal emitter and the intermediate layer has thermally conductive properties. The infrared radiation is partially transmitted through a metal ink image or emitted by a high emissivity ink image to provide a deceptive thermal signature.

### FEDERALLY SPONSORED RESEARCH OR DEVELOPMENT

N/A

### REFERENCE TO SEQUENCE LISTING, A TABLE, OR A COMPUTER PROGRAM LISTING COMPACT DISC APPENDIX

N/A

### FIELD OF THE INVENTION

The present invention relates to camouflaging techniques for hiding assets vulnerable to aerial attack as well as deceptive techniques for creating thermal and visual decoys.

### BACKGROUND

A major topic of discussion within the military community has been focused on what the next war of the future will be like and how to prepare for it. At the present, these concerns frequently end up centering on the threats posed by drones. Recent progress in the field of artificial intelligence and aeronautics has allowed for the possibility of attacks being initiated by unmanned aerial vehicles (UAV) controlled by humans or machine learning algorithms. These machines commonly use visual light cameras during the daytime and thermographic cameras during the night to identify targets and attack them from the sky. The question is, How do you protect from this? One possibility is to trick the drones into attacking the wrong target. Alternatively, the target can be camouflaged to hide from the drone. In either case, visual and thermal signatures must be faked in an extremely convincing way.

Currently, image recognition algorithms can be designed to identify targets nearly as well as humans can if not better. Therefore, to fool these systems, a very high degree of photographic realism is paramount. Achievement of this objective can result in drones being made to attack decoy targets, thus wasting munitions, or to overlook existing military targets due to appearing as an innocuous object.

For the achievement of this goal, the deception mechanism would require the ability to protect in daytime and nighttime conditions. Nighttime deception will require the use of a method to mimic thermal signatures. Although many rudimentary techniques have been employed in the past for daytime visual deception (mimesis, disruptive coloration, dazzle camouflage, etc.), there are few techniques designed specifically for nighttime deception. Deceptive methods used in daytime conditions are very well-known but still to this day extremely simplistic. In practice, these methods can be classified into two primary forms, partial camouflage and complete camouflage. Partial camouflage involves the use of incomplete mimicking of the surroundings or a form of optical illusion in which defects in a visual system are exploited. In both instances of partial camouflage, discernable features of the underlying object remain. A common example would be the camouflage produced by an octopus, which modifies its coloration and texture but maintains its overall shape which can indicate its presence. This technique has problems since if any identifiable feature of the original target remains, in theory, it should be possible to still recognize it. The only technique that can be completely entrusted to fully conceal an object and be fully impervious to subversion is complete camouflage. This would occur when the target is completely masked so that no identifiable feature of the underlying target is visible. Although this technique protects the identity of the target, it can potentially be distinguished as a ruse in and of itself by visual incongruencies it may introduce between the mask and the environment. This patent will prescribe a method for overcoming these problems.

### SUMMARY OF THE INVENTION

In this patent, a method and system for achieving complete camouflage in daytime and nighttime conditions will be outlined. For the techniques to be described, the nighttime protection method will be referred to as “Metal Image Lithophane Printing” (MILP), after the conventional use of the word lithophane, meaning a patterned thin piece of translucent porcelain used to form an image when backlit. This method can be combined with a daytime fooling technique, that will be referred to as “Alpha Composite Masking” (ACM), which complements and enhances the overall nighttime deception method.

The technical problem addressed by this patent is that advances in UAVs, machine image recognition, and aerial inspection at high resolutions have rendered existing camouflage techniques ineffective. The present invention is designed to thwart these deficiencies by addressing three fundamental questions: How do you protect against daytime and nighttime identification? How do you achieve complete camouflage without exposing the presence of a mask's edge? How do you solve a shadowing problem created by the presence of a concealing mask? The present invention employs the use of camouflage to conceal and optionally decoy images to deceive.

In this patent, several methods and systems for creating images used to deceive thermographic cameras in daytime or nighttime conditions are described. Additionally, this patent makes claim to several methods and systems for deceiving cameras that operate in the visual spectrum (conventional cameras), the infrared spectrum (thermographic cameras), or those that employ full-spectrum photography. The latter methods can be used in conjunction with the thermographic fooling techniques to improve the performance.

Images that can fool thermographic cameras will be achieved by using a printer that can print in both standard color ink and metallic ink. These printers will be used to print an image of a military decoy, military target, or an innocuous object onto a flexible transparent plastic film. Attached to the backside of the plastic film is a uniform thermal emitter. In analogy to translucent porcelain lithophanes, the infrared light transmitted by the thermal emitter is selectively blocked by the metal ink above. Since the metal ink is printed in the design of an aerial view of an object, areas with a more concentrated coating of the metal ink will block more of the infrared radiation whereas areas of the film with a less densely concentrated metal ink coating will allow for more of the infrared radiation to be transmitted. Optionally, an additional layer between the uniform thermal emitter and the plastic film with the metallic object printed on it may be added that has a low thermal conductivity to mitigate heat transfer between the two layers. In this arrangement, a thermal image is generated by using the metal ink to selectively block the infrared radiation that it is backlit with. As a result, highly dense metallic regions correspond to cold regions on the decoy object and low-density metallic regions correspond to hot regions on the decoy object. Throughout this patent, the term metallic ink refers to an ink composed of metallic particles embedded within a paste or liquid. However, it may also refer to a non-metallic ink that strongly absorbs or reflects infrared radiation.

Alternatively, a second method is described in which the thermal images are generated by using an ink with high emissivity to produce its own infrared radiation. In this arrangement, a uniform thermal emitter is affixed to the flexible plastic film with the image printed on it with the prescribed ink except that the high emissivity ink is made to be in good thermal contact with the uniform thermal source below. In this fashion, the temperature of the high emissivity ink regions will increase above the temperature of the environment, and they will preferentially emit infrared radiation of their own. Regions with more of the ink will emit more infrared radiation appearing hotter, and regions with less high emissivity ink will emit less infrared radiation and will appear colder. Unlike the first method and system just described, this method and system does not rely on blocking the transmitted thermal radiation generated from below to form the image but instead relies on thermal conduction and radiated emission by the high emissivity ink layer. Due to the frequency dependence of the emissivity factor, ink selection will depend on the spectra typically emitted by the decoys involved.

Both of these methods and systems utilize a printer that can print in a variety of inks onto flexible transparent plastic film. Either metallic ink or high emissivity ink can be printed solely, or metallic ink and standard colored ink or high emissivity ink and standard colored ink can be printed in unison on the same transparent film. The dual printing of the two inks can be used to generate both images to fool a thermographic camera and a standard visual spectrum-based camera or a full-spectrum-based camera at the same time. This patent describes several methods for performing this inking arrangement. In one of the methods, a layer of metallic or high emissivity ink is deposited upon which a layer of standard colored ink is deposited on top. The thickness of the underlying metallic or high emissivity ink is varied with location to generate the infrared image. In another of the methods, the metallic ink and standard ink or the high emissivity ink and standard ink are deposited in the form of dots arranged in a horizontal configuration. In this fashion, varying the dots per inch of metallic or high emissivity ink controls the thermal variations that appear in the formed infrared image. In yet another method, two layers are printed in a similar fashion to the first method just described, except that the first layer instead uses a dot arrangement of metallic or high emissivity ink and one of the colors of the standard ink. In this fashion, the first layer varies the metal or high emissivity ink density by a technique similar to the second method described above, but the visual spectrum image is created by the purely standard colored ink layer that is deposited on top of this first layer.

In addition, this patent describes a method and system for assembling the plastic film. The thermal emitter can be powered by a camouflaged or non-camouflaged solar panel, battery, and power controller. Alternatively, mains electricity may be used. The film can be laid flat and held taught on the ground, draped around a target to form a three-dimensional effect, or can be held taught with transparent poles as a canopy above a target that the deployer wishes to conceal. In these arrangements, the image printed on the plastic film can be that of a decoy and/or that of the environment to camouflage the image below it so as to appear that no target is present. To create large-sized thermal and visual deception, multiple film sections can be spliced together for large-scale deception such as by providing the ability to fake the presence of a building when no building is present or hiding a building by draping it with the camouflaging film.

In this patent, a method and system for blending the images into the ground environment below the flexible transparent film is presented. A fully opaque photographic quality aerial image of a decoy can be printed on the transparent film. Surrounding the decoy can be printed a representative aerial view photographic image of the environment that gradually increases in transparency to blend into the ground below it. This is the solution to the edge visibility problem generated by complete camouflage described in this patent. Using this technique, the incongruent edges of the mask image with the ground can be seamlessly blended into one another. This method and system described in this patent is designed to fix this edge visibility problem so as to still allow for the advantages of complete camouflage.

This method is achieved through the following steps. First, a high-resolution photograph, either thermal or visual, is acquired that contains some of the representative background that the target would be found on. Next, the edge of the environment area of the image is irregularly cut. Next, the edges are made increasingly transparent towards the edges using a Gaussian functional form. Next, the apparent brightness of the edges is increased using a Gaussian profile. Finally, when the image is superimposed on top of a target stationed on a similar environment it will blend into the ground below it. The steps are designed to eliminate a shadowing problem that occurs at mask's edges in cases when the film is arranged as a canopy above an object. This modification is designed to compensate for the shadow that is cast by the mask. Alternatively, no environment background image can be included in the printed film such that the clear region of the film abuts the printed fully opaque decoy image. However, this comes at the price of creating shadows at the boundary of the opaque and transparent region of the film. Also, it limits the size of decoys that can be used to shield the given target. For example, a tank image can't be used to hide a large building since it would be too small to cover the area to be hidden. Increasing the size of the tank image would result in an unrealistically large decoy that could be identified based on this anomalous feature alone. The ACM technique, in contrast, allows for the inclusion of large segments of environmental background which can be used to shield large objects.

Lastly, this patent describes a method and system that involves an underlying and varying lighting system that can be used to mimic moving seawater when these methods and systems are used in a canopy arrangement to protect a watercraft. In this system, a canopy above a watercraft with a photographic image of the water is printed on a transparent plastic film. The water image is made to be semi-transparent throughout. The film is made to overhang the watercraft with transparent poles that it is affixed to at each corner. Below the film, a moving and/or varying light source and/or projector light source that is used to shine a light from below at the underside of the film. From above, the image generated will contain the light variations and motion effects that can be used to simulate the effects of moving waves, thus hiding the watercraft.

### DESCRIPTION OF THE DRAWINGS

FIG. 1 is a cross-sectional view of a multi-layered film.

FIG. 2 is a plan view of a multi-layered film with a photographic image of a tank printed on it in metallic and/or standard color ink.

FIG. 3 is an illustration of the MILP method for selectively blocking infrared radiation to form a photographic quality image of a tank.

FIG. 4A is a diametric view of a fighter aircraft underneath a canopy suspended from transparent poles with an aerial image of the environment printed using the ACM method.

FIG. 4B is a plan view of the illustration in FIG. 4A.

FIG. 4C is a diametric view of a satellite dish underneath a canopy suspended from transparent poles with an aerial image of the environment and a deck gun printed using the ACM method.

FIG. 4D is a plan view of the illustration in FIG. 4C.

FIG. 5 is a graph illustrating how the printed image's opacity changes near the film's edge.

FIG. 6 is a graph illustrating how the printed image's lightness changes near the film's edge.

FIG. 7 is an elevation view of a film in a canopy arrangement showing how a ray from the sun bisects the film to form a shadow.

### DETAILED DESCRIPTION OF INVENTION

The technical question addressed in this patent is, How do you cause humans and machine learning-based algorithms to misidentify objects on the ground as seen from an aerial view? This requires producing a highly realistic photographic quality mask that can emit both infrared and visible light. In addition, the mask must be able to blend into the landscape without indicating its edge or indicating its shadow. This invention presents a solution to this problem in the form of a multi-layered film with fully opaque and semi-transparent regions.

FIG. 1 is a cross-sectional view of a multilayer film 10. The top layer in FIG. 1 is an image layer 12. The image layer has a metallic ink and/or color ink photographic image. An intermediate layer 14, whose presence is optional, has either very high or very low thermal conductivity depending on the requirements of the application. In the preferred embodiment, layer 14 has low thermal conductivity. The bottom layer 16 has a thermal emitter, preferably a uniform thermal emitter. The intermediate layer 14 allows the infrared radiation produced by the bottom layer 16 to be transmitted to the image layer 12 while minimizing heat conduction from the bottom layer 16 to the image layer 12. The purpose of having an intermediate layer 14 with low thermal conductivity is to prevent image layer 12 from increasing in temperature and emitting its own thermal radiation. The metal ink photographic image on the image layer 12 blocks some, but not all of the thermal radiation so that the metal ink image appears as the thermal image of the decoy to complete the deception. The assembly of these layers provides for a visible spectrum image and an infrared spectrum image that is detectable by visual inspection from elevated ground and the air. The image layer 12 can be printed with a printer capable of printing with metal ink and color ink in one of two possible arrangements. Either the metal and color ink can be printed in unison on a single horizontal layer or the metal ink can be printed first followed by a layer of color ink on top. In the latter arrangement, the underlying metal ink layer can consist of metal ink whose concentration can be modified by either varying the thickness of the metal link layer or by varying the dots per inch of the metal ink with a color ink as the diluting component.

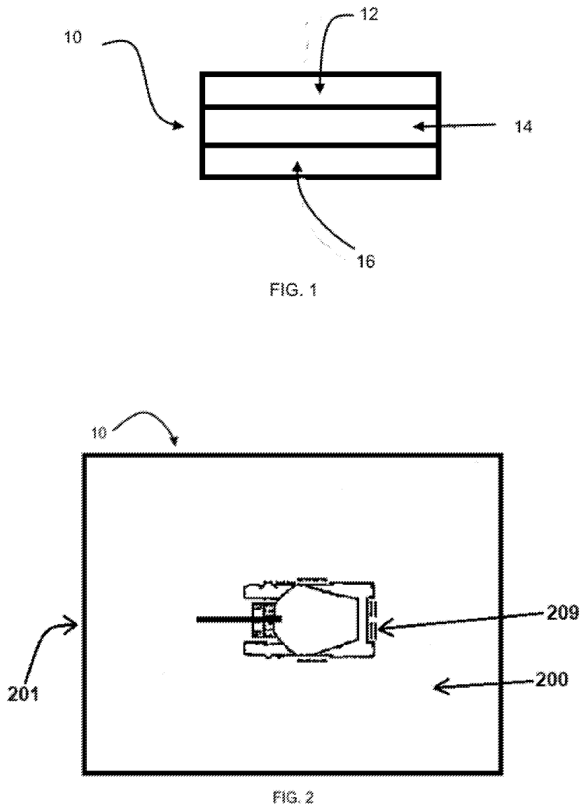

FIG. 2 shows a plan view of the multilayer film 10. The image layer 12 has a central photographic decoy image portion 209 that in this particular case shows a decoy image of a tank and an environment region 200 that may include an image of the background environment. 201 identifies the edge of the multilayer film 10. The central decoy image portion 209 is printed with the metallic ink to selectively block the transmission of the infrared radiation and form a thermal image when viewed from above. A color ink image may be printed above this metallic ink image to provide a visible decoy as well. Preferably, the two images are of the same object photographed from the same perspective. The image printed with color ink is photographed with a standard camera whereas the image printed with the metallic ink is photographed with a thermographic camera. The two images are made to overlap.

FIG. 3 illustrates the transmission of the infrared radiation from the uniform thermal emitter in the bottommost layer through a metallic ink layer and a color ink layer. No intermediate layer for blocking thermal conduction is shown for clarity. Instead, a plastic sheet is shown that forms the base of which the metal and color ink layers are printed. The infrared radiation is diminished as it passes through the metal ink layer and passes undiminished through the standard color ink layer. The metal ink image has a varied density so that it blocks the infrared radiation and forms an image of a decoy. The cooler regions of the thermal image generated have a thicker or more concentrated metal ink deposition and the hotter regions of the thermal image have a thinner or less concentrated metal ink deposition. The infrared radiation from the thermal emitter is partially blocked, varying in degree by the metal ink concentration, thus creating a realistic thermal image of the decoy when viewed with a thermographic camera from above. Preferably, the thermal emitter on the bottommost layer is uniform.

Another embodiment has the intermediate layer 14 as having a high thermal conductivity. In this embodiment, a high emissivity ink image layer 12 has either a positive or negative image of the decoy. The bottom layer thermal emitter 16 heats the high emissivity ink portion of the image layer 12 by the conductive transmission of the heat through the intermediate layer 14. In this embodiment, the high emissivity ink portion of the image layer 12 heats up to emit its own thermal radiation. In the thermal image formed, cold regions correspond with regions with low concentrations of the high emissivity ink and hot regions correspond with regions of high concentration of the high emissivity ink. In this embodiment, concentration refers to the number of dots per inch of high emissivity ink printed within a given region. Preferably, the intermediate layer 14 also blocks infrared radiation emitted by layer 16. In the case when a negative image is used on layer 12 it behaves like a photographic negative.

The metallic or high emissivity ink decoy image has a variable concentration or thickness. The variable concentration or thickness of the metallic or high emissivity ink decoy image allows for the formation of a deceptive thermal image either as the inks selectively block the infrared radiation or as they selectively produce their own thermal radiation.

The image layer 12 also has a color ink image for deception in the visible spectrum in addition to the thermal deception created by the metallic or high emissivity ink. The term ink as applied to both color, metal, and high emissivity is meant to include any type of ink, formation, or deposition method onto the film layer. The image can be printed, sprayed, or otherwise deposited on the transparent image surface 12.

When a multilayer film 10 is laid atop the ground or suspended as a canopy, its presence can be identified by incongruencies between its edge and the environment below it. The solution to the edge problem is to prevent the identification of the presence of a film that might be apparent to the human eye or an edge detection computer algorithm. Detection of such a dissimilarity would identify the image as a ruse. Edge detection algorithms employ different mathematical techniques for identifying sudden changes in an image's brightness. In doing so, they are able to establish the locations of objects in a given image and to simplify the features of the image for subsequent classification by a machine learning algorithm.

To defeat edge detecting algorithms, this patent describes a technique that modifies the transparency and lightness of the printed image towards the edge. This technique uses a rectangle or a convex shape and a modification of the transparency of the image adjacent to the specified shape's edges. In this embodiment, the plastic film that the images are printed on is transparent to visible and infrared light. The convex shape can consist of linear line segments or be composed entirely of a smooth curve.

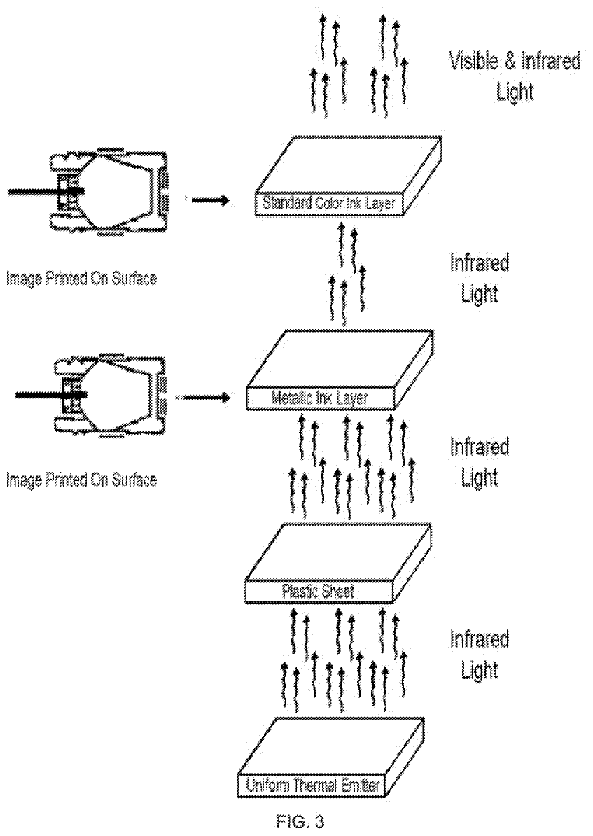

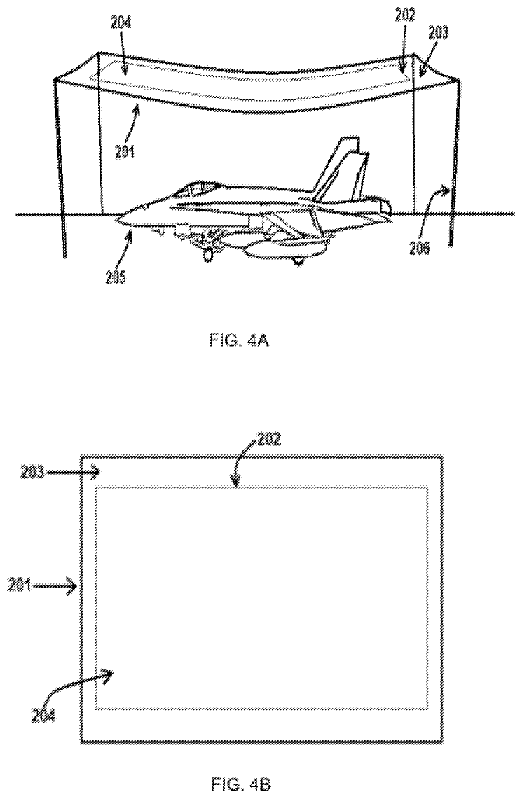

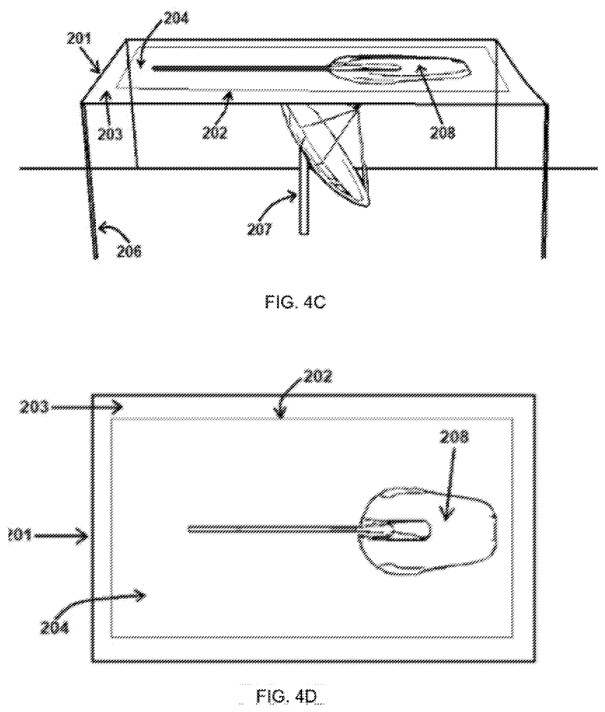

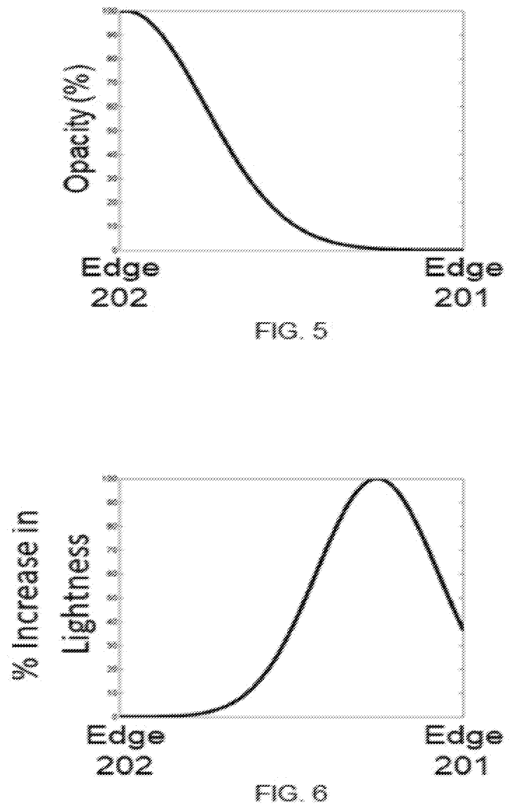

FIG. 4A, FIG. 48, FIG. 4C, and FIG. 4D illustrates a canopy film arrangement suspended from transparent poles 206. In the simplest embodiment, FIG. 4A shows a diametric view of a potential target 205, in this case, a fighter aircraft on the tarmac, being hidden from aerial view. The film is composed of transparent plastic with a fully opaque photographic image of the ground below the aircraft printed in region 204. The word opaque refers to the printed ink fully blocking all light transmission from the ground below. Furthermore, in this embodiment either the uniform thermal emitter 16 is not present and the ink used is standard color ink (no thermal deception present) or 16 is made of a material transparent to visible and infrared light. Starting at the edge 202, the printed image of the ground below is then made to be increasingly transparent toward the film edge 201, following a Gaussian functional form shown in FIG. 5, until when at the edge it is fully transparent. This background blending that occurs in region 203 is intended to hide the film's true edge 201 by mixing both the image created by emitted light from the ground below with the image formed by light emitted by the ink on the film. The variation in the printed image's opacity is accomplished by using the negatively sloped portion of a Gaussian function although this patent also encompasses the use of all other functions. The combined effect of an irregularly cut edge pattern and alpha compositing is to allow the transmission of the ground environment to be transmitted through the transparent regions of the film and cause it to blend. In this particular rectangular pattern arrangement, the transparency change proceeds perpendicular to each line segment of edge 202. At the corners of the line segments, the opacity decays as a Gaussian, proceeding radially from the corners. In the most general arrangement, a convex or concave shape is used for the boundary between the fully opaque region and the opacity changing region, and a two-dimensional function prescribes the opacity outside the shape where the function is chosen so as to have a contour line that follows the shape. When the film is not held flat, a three-dimensional function would be used whose isosurface that corresponds to full ink opacity resides on the prescribed curve.

When viewed from above, the target 205 will be hidden from view and the presence of the mask's edge hidden as well. In FIG. 48 a plan view is shown of the arrangement illustrated in FIG. 4A. In the line drawing, the film edge 201 and the rectangular full ink opacity edge 202 are shown. In another possible arrangement shown in FIG. 4C (diametric view), a photographic quality decoy image 208 (in this particular case a deck gun) is printed in addition to a photographic image 204 of the ground below printed surrounding the decoy. The target being hidden in this case is that of a satellite dish 207. In addition to a visible light image printed in 204 and 208, a metallic ink image of the deck gun may be printed below this, exclusively in region 208. In this embodiment, the thermal emitter 16 can be opaque in the visual spectrum so long as its location is restricted to reside underneath region 208. FIG. 4D shows a plan view of FIG. 4C. When viewed from above, the deck gun will be visualized instead of a satellite dish.

In a canopy arrangement, the films can be used to cover targets below it, thus providing protection to them. Other options for deployment would include laying the film flat on the ground or draping it overtop of targets or objects such as rock outcroppings, hillocks, vegetation, or built structures. This draping technique has the advantage of providing a 3-dimensional quality to the images so as to provide protection against low flying UAVs or humans on the ground. A specific application to this configuration may be to camouflage buildings by draping a large printed film sheet over top to make the building appear like a hillock or rock outcropping. In large-scale applications, the films can first be printed in smaller sections. These smaller sections can then be spliced together to form massive continuous sheets.

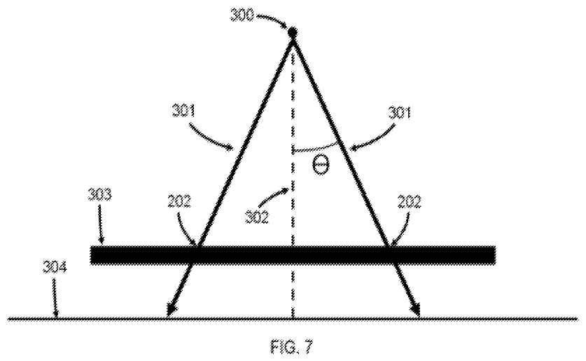

In the canopy arrangement, a secondary problem emerges since the film may cast a shadow due to the sunlight above it. To compensate for this underlying shadow beneath the film, an increase in the printed dot's lightness may be included following a Gaussian form as shown in FIG. 6. As shown in FIG. 7, the length of this shadow is determined by the angle 8 that the sun makes with respect to the vertical 302 and the ray 301 that bisects the sun 300 and the opacity transition edge 202. If not compensated for with the edge transparency modification and lightening, the shadow cast on the ground 304 by the canopy 303 will darken region 203 of the film when viewed from above, thus indicating the presence of something generating crypsis. The length of region 203 can be selected so that the shadow mostly encompasses this region. Any lightness scale may be utilized for this application. Furthermore, in a rectangular pattern arrangement as shown in FIG. 4A, FIG. 48, FIG. 4C, and FIG. 4D, the lightness increase proceeds perpendicular to each line segment of edge 202. Starting at the edge 202, the image is printed with the same lightness value present in the photograph printed in region 204. It then increases in value and then decreases towards edge 201. In the preferred embodiment, a Gaussian functional form would be used although any function may be used. At the corners of the line segments, the lightness increases as a Gaussian, proceeding radially from the corners, and then decreasing towards the edge 201. This lightness increase is the percentage change of the lightness of the dots from the original image to be printed. In the most general arrangement, a convex or concave shape is used for the boundary between the fully opaque region and the opacity changing region, and a two-dimensional function prescribes the percentage change of the lightness outside the shape where the function is chosen so as to have a contour line that follows the shape and corresponds with 0% change in dot lightness from the original image. When the film is not held flat, a three-dimensional function would be used whose isosurface that corresponds to 0% change in dot lightness from the original image resides on the prescribed curve.

Another embodiment is a fourth protective layer above and adjacent to the image layer. Preferably, the protective layer is scratch-resistant, may contain ultraviolet protective coatings to minimize damage from solar radiation, and may contain an anti-reflective coating to eliminate glare from the sun.

Another specific embodiment is to use a protective canopy to camouflage a watercraft from aerial visible identification. This is achieved by using a landscape photographic quality image of the water that the watercraft is upon. However, unlike the proceeding methods prescribed, the opacity variation presented in FIG. 5 is slightly modified such that the maxima of the Gaussian corresponds to a value less than 100% at edge 202 and extends as a constant throughout region 204. In this fashion, the entirety of the canopy is semi-transparent with no fully opaque regions. The edges still blend into the background by increasing the transparency of the edges using the Gaussian functional form and varying the lightness as indicated by FIG. 6. To complete the illusion, a modulating light source from below the canopy, stationed on the watercraft is shined up onto the bottom of the canopy. The canopy is suspended so as to overhang the hull of the watercraft and reside above the water. When viewed from above a varying image of waves will be present achieving a form of counter-illumination.

Although specific advantages have been enumerated above, various embodiments may include some, none, or all of the enumerated advantages. Other technical advantages may become readily apparent to one of ordinary skill in the art after review of the following figures and description.

It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise specifically noted, the articles depicted in the drawings are not necessarily drawn to scale.

Modifications, additions, or omissions may be made to the systems, apparatuses, and methods described herein without departing from the scope of the disclosure. For example, the components of the systems and apparatuses may be integrated or separated, and negatives of the images used. Moreover, the operations of the systems and apparatuses disclosed herein may be performed by more, fewer, or other components and the methods described may include more, fewer, or other steps. Additionally, steps may be performed in any suitable order.

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

1. A camouflaging flexible multi-layered film comprising:
an image layer having a printed image;
an intermediate layer under said image layer; and a base layer under said intermediate layer.

2. A camouflage flexible multi-layered film according to claim 1 wherein said image layer has a central image portion and an edge portion, said central portion opacity is greater than the opacity of said edge image portion or fully opaque.

3. A camouflage flexible multi-layered film according to claim 1 wherein said image layer has a central image portion and an edge image portion, said edge image portion having a varying and/or increasing lightness and said central image portion having the same lightness as in the original image.

4. A camouflage flexible multi-layered film according to claim 1 wherein said image layer has an edge image portion wherein said edge image has an irregularly cut convex curve pattern.

5. A camouflage flexible multi-layered film according to claim 1 wherein said image layer having a central image portion and an edge image portion, said edge image portion has its transparency varied toward the edge to blend into the ground.

6. A camouflage flexible multi-layered film according to claim 1 wherein said image layer portion having a central image portion and an edge image portion, said edge image portion is made semi-transparent by following a Gaussian functional form or other functional profile.

7. A camouflage flexible multi-layered film according to claim 1 wherein said image layer having a metal ink image of varied thickness or density, and a color ink adjacent to said metal ink image.

8. A camouflage flexible multi-layered film according to claim 1 wherein said image layer has a top surface, said top surface having a metal ink image of nonuniform thickness or density, and a color ink image positioned registered with said metal ink image.

9. A camouflage flexible multi-layered film according to claim 1 wherein said base layer has a thermal emitter and an image layer having a metal ink image above it used to selectively block the transmission of thermal radiation emitted by the base layer.

10. A camouflage flexible multi-layered film according to claim 1 wherein said base layer has a thermal emitter and an image layer having a high emissivity ink image above it is used to selectively emit thermal radiation conducted to it by the base layer.

11. A camouflage flexible multi-layered film according to claim 1 wherein said intermediate layer is of a thermally conductive material.

12. A camouflage flexible multi-layered film according to claim 1 wherein said intermediate layer is a thermally nonconductive material.

13. A camouflage flexible multi-layered film according to claim 1 wherein said base layer has a thermal emitter, a thermally nonconductive intermediate layer and an image layer having a metal ink image.

14. A camouflage flexible multi-layered film according to claim 1 wherein said base layer has a thermal emitter, a thermally conductive intermediate layer and an image layer having a high emissivity ink image.

15. A camouflage flexible multi-layered film according to claim 1 wherein said image layer has a central image portion and an edge portion, said image layer having an lightness gradient increasing following a functional form from said near edge location to said edge.

16. A camouflage flexible multi-layered film according to claim 1 wherein said image layer has a central image portion and an edge portion, said image layer having an opacity gradient decreasing following a functional form from said near edge location to said edge.

17. A camouflage flexible multi-layered film according to claim 1 wherein a protective layer and/or anti-reflective layer is adjacent and above said image layer top surface.

18. A camouflage flexible multi-layered film according to claim 1 wherein said image layer has a top surface and a protective layer is adjacent above said image layer top surface, said protective layer is scratch-resistant, protective of ultraviolet radiation, and/or anti-reflective.

19. A method of making a camouflage image:
a. depositing at least one image on a film wherein said image layer has an image center portion and an image edge portion, said film having an opacity gradient from semi-transparent to transparent;
b. creating and irregular cut pattern to said image edge portion;
c. varying the transparency of said image edge portion; and
d. lightening said image edge portion.

20. A method of making a camouflage image according to claim 1 having an additional step of protecting said image with a protective layer.
